(19) United States
(12) Patent Application Publication
(10) Pub. No.: US 2017/0032382 A1
(43) Pub. Date: Feb. 2, 2017

(54) System and Method for Product Authentication

(71) Applicant: Jenda Tag, LLC, Englewood, NJ (US)

(72) Inventors: Harry L. Shulman, Englewood, NJ (US); Jitong Zhang, Shandong (CN)

(21) Appl. No.: 15/304,196

(22) PCT Filed: Apr. 1, 2015
(86) PCT No.: PCT/US15/23766

§ 371 Date: Oct. 14, 2016

Related U.S. Application Data
(60) Provisional application No. 61/979,437, filed on Apr. 14, 2014.

(51) Int. Cl. G06Q 30/00; G06K 7/10

(52) U.S. Cl. CPC G06Q 30/0185; G06K 7/10861; G06F 17/30268

(57) ABSTRACT

Techniques for product authentication are disclosed which employ both identification tags affixed to products and a central server to validate scanned tag codes. To verify authenticity of a product, a user may peel off a cover label from the identification tag to reveal a scannable or readable code/symbol, use a device to scan or read the code/symbol, and then transmit it to the central server for authentication. The central server determines, based on database records, whether the code/symbol is genuine and never scanned by another device before. If so, the product is deemed authentic, and a corresponding token is created and stored based on the unique combination of the code/symbol and an identifier of the device used to scan/submit the code/symbol. Any subsequent authentication request originating from a different device to the central server with the same code/symbol may receive a negative response about the authenticity of the underlying product.

### CROSS-REFERENCE TO RELATED APPLICATION(S)

This patent application claims priority to U.S. Provisional Application No. 61/979,437 of the same title, filed on Apr. 14, 2014, which is incorporated herein by reference in its entirety.

### FIELD OF THE INVENTION

The present invention relates generally to a system and method for authentication of products by consumers, distributors, retailers, and/or other parties.

### BACKGROUND OF THE INVENTION

It is known in the art that product counterfeiting exists and various methods for deterring counterfeiting and/or detecting counterfeits have been developed. Such countermeasures typically include techniques for attempting to authenticate and verify genuine products. These methods often fall into several categories but in general share similarities with inventory control methodologies. One of these is to attach unique codes, such as a Universal Product Code (UPC) to the packaging of a product in order to verify that it was packaged by and is an authentic product from the original producer. Unfortunately, these codes can easily be duplicated, replaced with fraudulent codes, or be removed or damaged thus rendering them ineffective for counterfeit detection. These codes can also be re-used for one or multiple times. Another problem is that authentic packaging can be filled with counterfeit products, again defeating this conventional system. Other systems use tokens such as holographic markers which can be attached to a product or its packaging and can be scanned to verify authenticity. However, these suffer from the same problem as UPCs in that the tag can be forged (albeit with more difficulty) and multiples of the same tag can be scanned and a central database is only able to indicate if the code itself is valid or not. Therefore duplicates of the tag, regardless of whether they are difficult to duplicate or not, can be used to defeat this conventional system as well. These tags are also often intended to be scanned multiple times for shipping, inventory tracking and other methods of accounting for products and must allow for multiple scans in the supply chain. In other words, their primary function for multiple-scan inventory tracking makes them unsuited to single-use counterfeit detection.

Another common problem with known scannable tags or codes is that even if they are covered or contained within the packaging, the customer is required to send them to a server by texting or calling a phone number or using an Internet connection that is provided for on the tag. This communication method that is provided on the tag can be replaced by a counterfeiter provider with their own number or address which will “validate” any counterfeit code or tag the counterfeiter has created, again undermining the ability to rely on these methods of verifying an authentic good. Furthermore, the problem of counterfeiting with current holograms and serial numbers has driven some to chip integration and mass spectrometry for verification of products. However, chip integration may not be practical and can be cost prohibitive for many products. It can still be counterfeited even though it is more difficult. Another method of product verification is mass spectrometry; however, this method requires specialized equipment and is typically only available to select personnel such as customs personnel and not the general public. These are only a few examples of the myriad of shortfalls of counterfeit deterrence systems in existence. Other problems and drawbacks also exist.

### SUMMARY OF THE INVENTION

An embodiment of the present invention comprises a central database that contains a listing of unique tag codes, each of which corresponds to a single physical tag that can be created and affixed to a product. The tag can be scanned by a mobile device (e.g., a cell phone, smart phone, tablet, phablet, portable computer, laptop, netbook, camera, optical scanner, visual image capture device, laser tag scanner/reader, and so forth) executing a software program that creates a secure communication channel with a central server. This software gathers properties of the mobile device to create a unique device identification code for the mobile device and allows for scanning of the tag for the unique tag code. The combination of the unique device identification code and unique tag code allows a token to be created (e.g., by the central server) that is unique to the device and tag combination which cannot be reproduced by using a different device or tag combination. This unique combination of device identification code and unique tag code is communicated to the central server 100, which verifies this code to be authentic if it is scanned for the first time. The server records the scanning for the first time of the code in the database as well as the unique device identifier that was associated with the unique token. A confirmation is then communicated back to the mobile device (or at least no warning is issued to the mobile device—“confirmation by silence”) so that the user can know that the product is genuine. Subsequent scans of the same tag by any other device, even if the device is running the same software, will result in a failure of authentication, e.g., by a message indicating that the product is or is likely to be counterfeit and/or that the tag has been re-used or otherwise misused.

In another embodiment of the invention, subsequent scans by the initial device, which is associated with the same unique token, of the same unique tag code will result in a notification that the product is genuine but may also indicate that the product has previously been scanned.

One technical effect of the present invention is a product authentication model based on client-server communications and central storage of authentication data which is difficult (if not impossible) for counterfeiters or fraudsters to defeat.

Another technical effect of the present invention is the crowd-sourcing of product information (potentially including data of both authentic and counterfeit products) and related user information from numerous parties (e.g., consumers, distributors, or retailers) from numerous locations, which information is valuable for a number of reasons as will be described below and such a large volume of data would otherwise be impossible (or too expensive) to collect.

The accompanying drawings are included to provide a further understanding of the invention and are incorporated in and constitute part of this specification, illustrate several embodiments of the invention and, together with the description, serve to explain the principles of the invention. It will become apparent from the drawings and detailed description that other objects, advantages and benefits of the invention also exist.

Additional features and advantages of the invention will be set forth in the description that follows, and in part will be apparent from the description, or may be learned by practice of the invention. The objectives and other advantages of the invention will be realized and attained by the system and methods, particularly pointed out in the written description and claims hereof as well as the appended drawings.

### BRIEF DESCRIPTION OF THE DRAWINGS

The purpose and advantages of the present invention will be apparent to those of skill in the art from the following detailed description in conjunction with the appended drawings in which like reference characters are used to indicate like elements, and in which:

FIG. 1 is a diagram illustrating an exemplary system for product authentication according to an embodiment of the invention.

FIG. 2 is an illustration of an embodiment of the invention illustrating the differences between an authentic initial scan (FIG. 2A) and a scan of a product that is not registered as authentic (FIG. 2B).

FIG. 3 is an illustration of an embodiment of the invention where one tag is linked to multiple other tags within a shipment.

FIG. 4 is a flow chart illustrating an exemplary method for product authentication in accordance with an embodiment of the present invention.

### DETAILED DESCRIPTION OF THE INVENTION

Embodiments of the present invention provide for product authentication which employs both unique scannable or readable tags affixed to products and a central server with a database to validate scanned tag codes. To verify authenticity of a product bearing such a tag, a user may peel off a cover label from the tag to reveal a scannable or readable code/symbol and then use a device to scan or read the code/symbol and transmit it to the central server. The central server determines, based on database records, whether the code/symbol is genuine and never scanned by another device before. If so, a corresponding token is created and stored based on the unique combination of the code/symbol and an identifier of the device used to scan/submit the code/symbol. Any subsequent authentication request originating from a different device to the central server with the same code/symbol may receive a negative response about the authenticity of the underlying product.

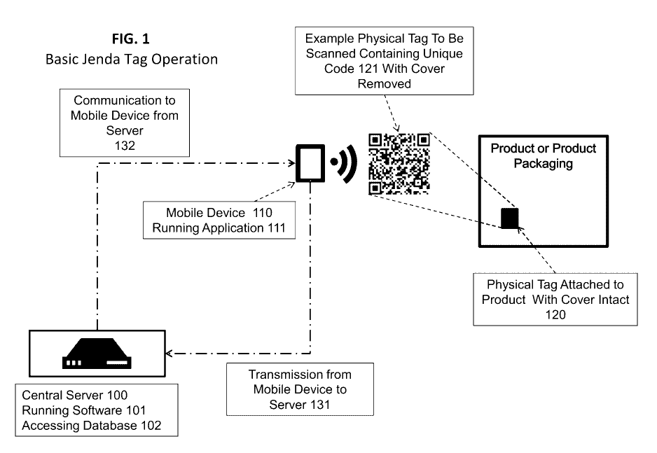

Referring to FIG. 1, there is shown an exemplary central server 100 running software 101 that maintains a database 102 of unique tag codes and associated information. For example, the database may store, for each tag, information such as (a) whether the tag is valid, (b) whether the tag has been scanned, (c) if it has been scanned, the unique token code associated with the tag, (d) the market for which the tag's underlying product is intended, (e) the manufacturer by which the tag is to be used, and so on.

FIG. 1 also shows a mobile device 110 running software 111 that enables the mobile device to communicate with central server 100 via communication pathways 131 and 132. Communications pathways 131 and 132 can be the same or different pathways. FIG. 1 additionally illustrates a product identification tag (sometimes referred to herein as the “Jenda tag”) prior to it being scannable in state 120 and an exemplary tag after the cover has been removed or product opened so the code 121 can be scanned from the tag by mobile device 110 and read by software 110 to be communicated for validation at server 100 (sometimes referred to herein as “Jenda server” or “Jenda central server”).

With reference to FIG. 1, in another embodiment of the invention, the tag may comprise a physical multilayer tag or label having visually readable and/or machine readable or scannable symbol such as a unique barcode or Quick Response code (sometimes referred to as “QR code”) that can contain a non-encrypted or an encrypted code which is sent to central server 100 for verification through database 102. The QR code can also be configured or programmed with information about which central server 100 or database 102 to contact for authentication and/or the mode of communication to be employed (e.g., an http handshake exchange of information, a mobile text push of information, an auto-dial of a phone number followed by transmission of DTMF tones or other analog or digital data, or other modes of communication supported by existing and future mobile devices etc.). Alternatively, the identity or location or access information for the central server 100 or database 102 to contact for authentication may be programmed into software 111. In the embodiment where server information is contained in software 111, this information can be updated via sending of data from server 100. In this way, the contact information for sending device code and product code pairs can be regularly changed, if needed, so as to defeat fraudsters.

In another embodiment of the invention, the Jenda tag also contains RFID information in addition to or instead of the optically readable tag or code. The RFID information could be designed to work with Near Field Communication (NFC) or any other standard RFID tag used in the industry.

In another embodiment of the invention, the code contained on the tag is affixed to the product and the tag has a covering that must be removed in order to enable scanning. Preferably, removing the covering requires destruction of the cover and cannot be repaired. In this way, the tag on the product must be tampered with in order to create a duplicate and users of the system, to include retailers and customers receiving the goods will see the defaced product and know it has been tampered with. Tampered tags can then be reported to the manufacturer to take appropriate action. It may also provide for reproduction of one tag for each tag that has had the cover destroyed. The association of the tag code within central server 100 with only one scanner will prevent mass duplication of tag. Only one usable tag will be capable of being created for each tag that is destroyed. Furthermore, combination with other embodiments will not allow fraudsters to use these tags with other products, e.g. showing a picture of the original product on which the Jenda Tag was affixed to and preventing it's use on other brands or types of products.

In another embodiment of the invention, a code or set of codes in the central database can be deactivated so that even if those code(s) are subsequently scanned for a first time, the system will indicate a failure to authenticate the product. In this way, the system can take preemptive action when intelligence reveals that codes have been compromised before they have ever been scanned and maybe before they reach the retailer at the end of the supply chain.

In another embodiment of the invention, database 102 maintains the unique mobile device identifier that is associated with a user's mobile device and this identifier can be updated such as if a mobile device is lost, stolen or replaced. Upon updating database 102 with the new unique mobile identifier, all of the tags and unique tokens associated with the previous unique mobile identifier will be transferred to be associated with the new unique mobile identifier.

The unique mobile device identifier can be any identifier adequate for identifying a scanning device, e.g., the serial number of a device, Mobile Identification Number (MIN), International Mobile Equipment Identity (IMEI) number, MAC address, and the like. The unique mobile device identifier of the scanning mobile device does not have to be stored identically in the database 102. It can be converted or translated into any identifier adequate to the task of uniquely identifying specific mobile devices. Indeed, while this application refers to “unique” numbers throughout, the term is not intended to be read so narrowly as to require that every number be positively unique. Rather, the concept is that whatever numbers are used to identify specific mobile devices the overall methodology is capable of differentiating between different mobile devices. Similarly, the mobile device identifier can be used as a seed for an encryption method, or the combination of the tag code and mobile device identifier can be used as a seed to run a hash, encryption, or other method to create a unique identifier that only that mobile device and tag code will produce and this can be what is stored in database 102. This action can take place on the mobile device, or at server 100 or anywhere in between.

In another embodiment of the invention, database 102 maintains an account with several unique mobile identifiers that a single user has and scanning by any of these identifiers after the first scan for authentication will result in authentication with a notice that the tag has previously been scanned by another device on the account. In other words, a user may effectively register multiple devices so that scan of a tag code with any of those devices will be treated in the same fashion.

In another embodiment of the invention, multiple user devices can be notified of a scan. If a user registers multiple devices, they can opt to receive notification on some or all of the registered devices each time they scan an item. Alternatively, if a scan of a product is made by someone after it is purchased and registered, any scan other than one producing the registered token will notify the registered user's device(s) of the scan. This can include time, location information and any other pertinent information regarding the scan. For example, the location in which the scan takes place—such as where the product is purchased, unpackaged, or consumed—may be determined with one or more location services or technologies available on the user's device or provided by the wireless or cellular networks (e.g., GPS, network-assisted GPS, cellular signal strength or triangulation, cell/sector of origin, and/or wi-fi location). The scan by anyone other than the registered user can automatically be sent to law enforcement if the product is registered as stolen or any other pertinent group (e.g., a central server, a monitoring service, or another destination) depending on the status of the product in database 102.

In another embodiment of the invention, server 100 is capable of sending a scan notification to multiple system users at the same time. This can be set up to send a genuine product notification to all mobile devices associated with an account in addition to the merchant, the manufacturer or any other entity that is designated by the software 101 or by the user of their account. The mobile device 110, through software 111, can forward notification of an authentic product to other users, be it within the Jenda Tag system or through other normal methods that Jenda software 111 can interact with, such as text or multimedia messaging systems, e-mails, social media posts, chat programs etc.

In another embodiment of the invention, the tag is enclosed within the packaging of the product and the packaging must be destroyed or tampered with in order to access the tag.

In another embodiment of the invention, the tag is affixed over a part of the product or product's packaging such that the tag must be destroyed in order to access the product. For example, a tag may be affixed over the top of a beer bottle so that it is ripped and rendered clearly “tampered with” when a consumer or other individual gains access to the beer. In another alternative embodiment of the invention, the unique code is printed directly on the product or its packaging, and a cover is affixed over the code.

In another embodiment of the invention, the unique token is created from the unique tag code and biometric identification of the user instead of or in addition to the unique device identifier. For example, the product (or even the tag itself) may include an area for a fingerprint to be placed and then scanned, along with the tag code. Alternatively, the mobile device may include software for receiving biometric data such as a finger print or eye scan or facial scan; such biometric data, or a unique identifier produced from the biometric data, may be stored in the database 102 to enhance product authentication.

In another embodiment, supplemental user authentication can be provided by scanning and sending information from a payment card (credit card, loyalty card, or even a special purpose product authentication card) that can be used to ensure that the person seeking to authenticate the product is who he/she purports to be. In an alternative embodiment, such payment card information may be used in lieu of (or as a proxy of) or in addition to above-described user device identifier and/or biometric data in creating the unique associations between authentication codes and corresponding users or user devices.

In another embodiment, additional information about the product is stored in database 102 and provided to the user at the time of scanning via mobile device 110. This information is used by the user to further ensure the product's authenticity, such as matching the product's serial number, expiration date, or other attribute present on the product to the number, image, or information displayed by application 111 via server 100.

In another embodiment of the invention, the central database maintains a record of all transfers of the tag (e.g., the tag ID, the token, or the combination of a device ID and product code). The central database is also able to maintain a list of all unique tokens that are associated with a specific tag, a specific mobile device or user.

In another embodiment of the invention, software 111 contains a mapping tool which can display retailers that sell authentic goods and retailers that sell or have sold non-authentic goods. Through GPS or other location functions, coupled with optional user inputs, the user device may identify retailers or retailer stores and forward their information along with the scanning results to the central server 100. For example, passive location data from customers may be supplied to the central server in combination with Google Maps data and/or explicit store location names provided by users. Each retailer that has sold a product with a Jenda Tag would be stored in database 102 which, over time, accumulates the crowd-sourced data about the retailers; and the resulting map information, retailer scoring or rankings contained in database 102 could be displayed to the user using software 111.

In another embodiment of the invention, the unique device identifier includes location based information, to include any one of, or combination of, but not limited, mobile device country code of the telephone number, the Visitor Location Registry (VLR) information of the mobile device, cellular tower information to which the mobile device is connected, GPS information, location determined by networks or any other method of identifying the location where the tag was scanned, and is communicated to the central server 100 upon being scanned. From this the specific location, country, market or other information can be determined by the location of where the tag was scanned. If the tag is scanned outside of an intended market, location etc. even for a first time, the central server 100 can communicate an indication of a non-genuine product or inform the user that the product is being sold illegally in that market or convey some other message.

In another embodiment of the invention, after the initial scan, the first user can notify the central server 100 or database 102 that the item has been transferred to a subsequent user (e.g., a watch having a Jenda Tag is purchased and scanned into the system, followed by a sale or gifting of the watch to a third party which is accompanied by a scan to change ownership status). This ownership transfer scan can replace the original unique token with the new unique token, based on the receiving user's combination of unique tag code and unique mobile device code or biometric data, and indicates that the product is genuine only when scanned to produce the receiving user's unique token. Scanning by any other device will indicate a non-genuine or stolen product. This gifting or sale process even can ask the original owner and/or subsequent owner to provide information about the transaction such as price paid, location of transaction from information provided by the users or as above by other geolocation technique, condition of the item or any other pertinent information that central server 100 or database 102 can then record. The transfer can be for a limited period such that after the time period the product will revert back to the original user and scanning by any device other than the original user will result in non-genuine or fraudulent result.

In another embodiment of the invention, the scanning by any other person other than the original scanner will indicate that the item is owned by the original scanner. The ownership of the product by the original scanner can be transferred to a second owner, and then to a subsequent owner etc., but requires authorization by the current owner to transfer and scanning by the subsequent owner to register it in their name similar to an initial scan or with additional step(s) to accept the product subsequent to the scan. Alternatively, a person purchasing a product and scanning it originally can pre-authorize a transfer such as register it for a subsequent owner in anticipating giving it as a gift or transfer, such that when the person receiving the product from the original purchaser scans it, it registers with them as their product without further need of confirmation of transfer. The product can subsequently be passed on from there to other owners if so desired.

In a particular example, a bar that plans on pouring a bottle of alcohol over the course of multiple nights to multiple patrons can scan the bottle and claim it on its own prior to serving it for the first time. Consumers can then scan the bottle thereafter (even if they are ordering just one drink). Jenda central server will tell them when the store first scanned the bottle and how many times the bottle has been scanned thereafter. A bottle that was scanned weeks ago and has been subsequently scanned by many other individuals may indicate a genuine bottle has been refilled with counterfeit alcohol. Additionally, application 111 may indicate to the user how many scans should be expected from a given bottle before the product is expected to be fully used. This information may be provided by the manufacturer or estimated based on the size of the bottle or provided based on the amount of the product the retailer/bar indicates they will pour in each drink or by some other information.

In another embodiment of the invention, the central database is capable of identifying when a Jenda Tag is scanned outside of an intended sales market or when a set of tags are scanned outside of a designated market. The server can flag this suspicious activity and communicate this suspicious activity to the monitors of the system or to the genuine owners of the products. The server can also automatically deactivate (e.g., by deleting the Jenda Tags or flagging the Jenda Tags in the database) tags that were sent together and are being scanned outside the intended market, country, or on products that the tags were not intended for. The tags if used with products other than the intended products or outside of the intended sales locations can also indicate fraud and the tags can be invalidated by the system and when scanned indicate a non-genuine product or display some other message.

In another embodiment of the invention, the scanning of the tags can be used by customs, law enforcement or other agencies to verify if the products that are being imported or exported are genuine or are counterfeits or frauds or are being illegally transported in a manner that may avoid applicable taxes, levies, or tariffs. Users of the system, such as private individuals, can also report tags that indicate a non-genuine product to the manufacturer, security or law enforcement authorities and/or the sales person and appropriate action can be taken. Action might include demanding a refund, and/or reporting to customs or law enforcement that the establishment is selling fraudulent goods so proper legal action can be taken. Users can also report/share this information on to manufacturers, brand owners, social media such as Facebook, Twitter, Yelp, Angie's List or other review sites to indicate that the products being sold are not genuine. The user can upload description and/or pictures of the location (and/or location information acquired with GPS or other technology), reviews of the merchant, the product that was counterfeit or otherwise suspect and any other information the user wishes to share. The software 111 can have an action set up by the user to automatically make a Facebook post, Twitter tweet, etc. to social media or internet location of choice upon scanning of the tag. The public showing/shaming of non-genuine goods being sold at these locations will reduce business at these locations and render counterfeiting and sale of non-genuine products much less profitable. This same information can be provided to manufacturers and brand name owners who can then follow up on these reports if they so choose or keep a running record of all locations that have sold their counterfeit or unauthorized goods.

In another embodiment of the invention, scanning the product code and providing information to the manufacturer (or to the Jenda central server), or the company/retailer who sold the product such as where the product was purchased, what product was purchased, time of purchase, amount paid for the product, or any other information about the product or the transaction that sells the product can result in incentives being provided to the scanner of the product. These incentives can include coupons, discount codes, targeted advertisements, free products or other items from the manufacturer or seller. This can be on an opt-in basis for some or all of the information or advertising being provided. The incentives can be provided to consumers and/or to retailers or both.

In a particular example, new parents who have just purchased a batch of baby formula may immediately scan the authentication codes on all of the containers to ensure authenticity with the central server. Apart from confirming to these users the baby formula products are genuine and safe, the central server may at the same time come to know approximately when these users will need to purchase more baby formula. At the appropriate time, a reminder to re-order may be sent to these users, possibly along with a coupon or discount code as a further incentive to purchase the same products.

In another embodiment of the invention, records of products scanned, be they genuine or not, by a unique device identifier or user can be amassed and analyzed for targeted sales, advertisement, and offers to be made to the user. These can be communicated to the user via e-mail, text message, a push notification via the smartphone application, or any other method suitable for the user. The communications can also be provided through the application software directly.

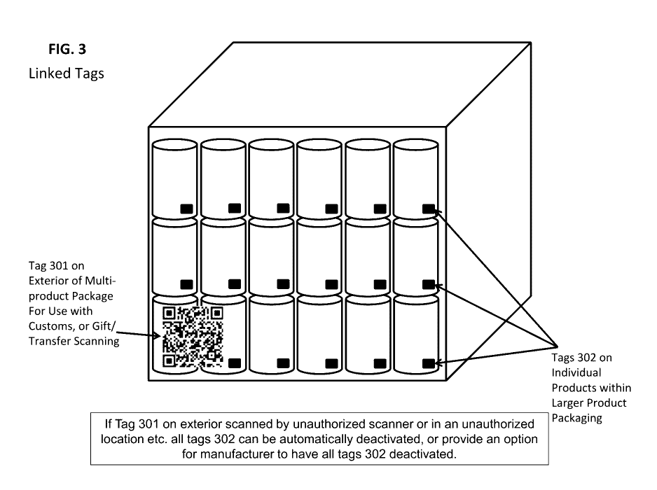

FIG. 3 is an illustration of an embodiment of the invention where one tag is linked to multiple other tags within a shipment or a package. As shown, an exterior tag 301 affixed to the outside of a multi-product package is designed for inventory control, customs import/export monitoring such that the exterior tag can be scanned multiple times for tracking, while the tags 302 contained within the shipment/package are linked with the exterior tag 301 in database 102, such that all of the tags 302 can be deactivated at once, or the tags 302 can be shipped deactivated and are activated upon final scanning by the intended recipient of the shipment.

In a particular example, a retailer can scan a code on a case to register all products contained within that case to the retailer. For example, a Walmart employee can scan a case of baby formula to associate each product and accompanying code within that case to Walmart. When a consumer scans the baby formula after purchase, he can see that this product should be sold at a Walmart. This will help strengthen consumer confidence in the retailer, and potentially make it more difficult to resell stolen goods. In another embodiment, the retailer would not have to scan a case, and instead all products contained in case X destined for retailer Y would be pre-associated with the retailer before leaving the manufacturing facility. In another embodiment, a retailer that has scanned a code on a case to register all products contained within that case to the retailer can assign ownership of a specific product during checkout to a specific consumer. When the consumer scans the tag, application 111 may indicate that the product is the property of the consumer based on the information provided by the retailer. This embodiment would provide further confidence to the consumer that the product is legitimate and that the retailer is trustworthy since the retailer and manufacturer are working together to ensure product authenticity.

With a system like the one above in place, the manufacturer and/or server 100 could collect and leverage data specific to individual retail locations. For example, when cross selling or upselling or otherwise communicating with consumers via the smartphone application, the application could use everything it knows about the specific retail location the consumer is currently at (or is known to shop at) to ensure the products being recommended are available at that location. At a bar, for example, the Jenda app (and/or Jenda server) could use the knowledge that inventory at this location includes brands of beer A, C, and D. The knowledge that brand B is not sold at this location is useful, because recommending that brand to the consumer via the Jenda application would be ineffective if it is not available for purchase at the time.

Additionally, the manufacturer can use this data in sales meetings with the retailer, as the manufacturer will know what products are selling at each individual retail location, how effectively they are selling, and which other products would likely sell well at any given location.

Furthermore, the manufacturer and/or server 100 could collect and leverage data specific to individual consumers, for example, to understand and/or predict their purchase habits, consumption patterns, and future demands. Accordingly, advertisements, product suggestions, re-order reminders, promotional data, and/or product safety warnings may be pushed to the consumers' user devices via the Jenda app and/or Jenda server.

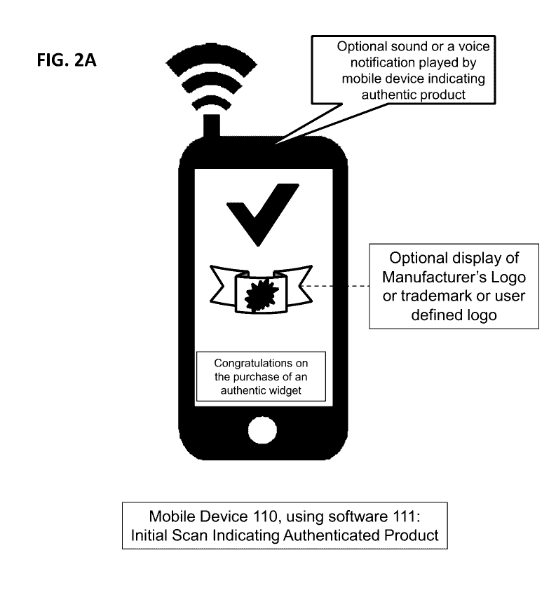

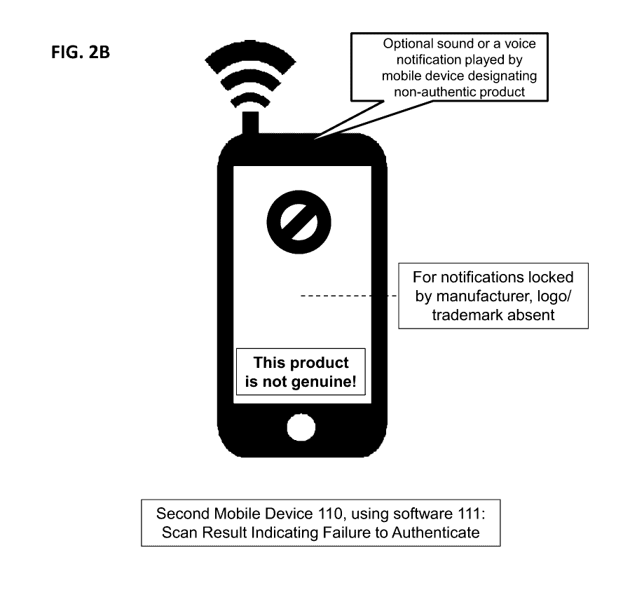

Jenda Tags, the unique physical tags, are sent via secure shipment method to a manufacturer for attachment to their products. The shipment can be in a method that is tamper evident and indicate if the package has been opened, damaged, or been manipulated in any way. Upon receipt by the manufacturer, the manufacture will verify that the tags have not been tampered with. If there is any evidence of tampering, the manufacturer can notify Jenda Tag and the unique codes contained database 102 of the central server 100 can be disabled immediately. New tags can be shipped to the manufacturer immediately. Even if the tags do not arrive in the allotted time, or are delivered to someone other than the intended recipient or for any reason that may raise suspicion, the tag codes in the shipment can be deactivated in database 102. The deactivation of a tag code may involve disassociation of the code with a genuine product and communicating a message in response to an authentication request to indicate that the product is not authentic and possibly to suggest that the customer should contact law enforcement. The manufacturer chooses an appropriate method of attaching the tags to the product(s) or product packaging that is suitable to the manufacturer's needs. Examples of adhering are shown in FIG. 2.

The software 111 running on the mobile device 110 is a secure system in that it is preprogrammed to communicate with server 100. Preferably, software 111 cannot be modified or tampered by a user to contact any other server than that preprogrammed into it. Changes in the communication method would originate from server 100 or its subcomponents, to include any software or hardware that is running or controlled by server 100 such as software 101 and database 102, and be communicated to mobile device 110 and software 111. The software 111 and software 101 have a method of verifying that each is running genuine Jenda software. This will prevent counterfeiters and purveyors of non-genuine products or non-genuine Jenda Tags from using fraudulent tags or reusing tags because the software will not communicate with any other server other than the genuine central server 100 that the software 111 is designed to communicate with. The communication methods and pathways 131 to the server from the mobile device and from the server to the mobile device, 132 can be any normal method of communicating data, to include but not limited to cellular telephone networks, internet connection, plain old telephone system networks, wifi networks, or any combination of these. Pathways 131 and 132 can be different pathways or the same pathway.

If a Jenda Tag is scanned by a mobile device 110 that is not running Jenda Tag software 111, the scan would not be communicated to server 100 and therefore would not verify the product as genuine. However, if software on the mobile device 110 is counterfeit and attempts to contact the server 110, the server can verify if the software on device 110 is genuine. If the software is not genuine, the unique tag code that has been scanned can be deactivated and the server will not respond to the communication request. The server can notify monitors of the system of the attempted fraud and provide any information related to and contained in the communication sent to the servers to take appropriate action such as notifying law enforcement or contacting the last known owner of the tag(s). These actions can also be set to be done automatically without further user input.

If anyone obtains one or more genuine Jenda Tag(s), they cannot create additional tags or multiple duplicates of a particular Jenda Tag which would have the ability to incorrectly display a positive product authentication using genuine Jenda software because the unique code 121 associated with each tag 120 is maintained in the central server database 102. Creation of fraudulent tags that are scanned with genuine Jenda software 111 would result in failed authentication attempts as well since there would be no corresponding codes in database 102. Duplication of a genuine Jenda Tag will not help the counterfeiter because the first scan of any of the duplicate tags that contain the same code will associate that code with a particular mobile device identifier to a unique token. A scan by a mobile device having a different mobile device identifier of the same code would fail authentication. This would result in a zero sum outcome for duplication or copying of tags. Furthermore, the covering of the Jenda Tag must be destroyed to gain access to the unique code and therefore would not be reusable. If the tag is contained within the packaging, the packaging must be tampered with or destroyed to obtain access to the code and again, the initial scan will associate the code with the unique mobile device identifier. In this way, a fraudster cannot obtain or create any more usable physical tags which contain unique Jenda Tag codes than the number of genuine Jenda Tags the fraudsters initially obtained and/or opened in a tamper-evident manner. Having to obtain genuine products and Jenda Tags prevents the fraudsters and counterfeiters from producing non-genuine products and selling them below cost and so dis-incentivizes counterfeiting or production of non-genuine goods that use Jenda Tags for authentication.

Furthermore, general knowledge among consumers that all genuine Brand X products have Jenda tags will make the counterfeit nature of fake Brand X products more apparent to consumers as they will expect to see a Jenda tag affixed to these products. In this way, even if counterfeiters realize it is impossible to reproduce functioning Jenda tags at scale, their counterfeit versions of Brand X products that do not have fake Jenda tags will still be more easily detected as counterfeits by consumers.

Multiple central servers 100 can be used together. Each server can be set to run in different regions, or to work with different manufacturers, or specific versions of software 111. This can help if products are moved from one region to another and an attempt to authenticate is received by a server in a region outside the intended market. Multiple servers can simplify tracking of products and if they are to be sold within a certain region, e.g. certain country code, specific zip code or only at certain stores. A specific server may be set to be responsible for all scans in a region and only authenticate specific codes assigned to that region or contained within its database 102. Alternatively, the server responsible for that region could forward authentication requests to the appropriate server responsible for the specific Jenda Tag depending on the manufacturer's desires and settings. A shipment itself can have a Jenda Tag on it that can be scanned by the retailer upon reception of the goods prior to opening of the shipment to verify that the goods contained within the shipment are genuine and from the authentic source. The products within this shipment each can also have Jenda Tags such that consumers can then scan the tags to verify for themselves that the products themselves are genuine. If the packaging tag is scanned by someone other than the intended recipient or in a region outside of the server's responsibility, all of the tags contained within the package can also be automatically deactivated. The system can be designed or configured so that the receiving scanner may have to input a password or some other form of identity verification to prevent automatic deactivation or alerts being sent to Jenda or the manufacturer. In addition to preventing black market or grey market sales, this would also prevent theft and could be applied to prevent theft at any point in the supply chain. This method can be used to help ensure products that are intended for one market are not without permission or illegally transferred and sold in another market. This can also be done with a single central server 100 with the location information that can be provided by a scan in normal authentication. The method of authenticating the exterior code by certain authorized users can also be used to determine if a wholesaler or another entity is selling or transferring products from one market to another and attempting to profiteer from this diversion of goods at the expense of the manufacturer. Even if the exterior tag is not scanned but a majority or all of the individual products that were associated with the shipment tag are sold/scanned outside of the designated market, the manufacturer can use the scans to determine where in the supply chain the shipment was diverted and where it was diverted to. In this situation, the manufacturer can deactivate all the remaining tags associated with the shipment's exterior tag.

Jenda Tags can be used for medication identification and verification that the medication itself is authentic. For individually wrapped or dose wrapped packages of pills, the backing itself can consist of the Jenda Tag itself or it can be attached to the exterior packaging or attached in any convenient method to the wrapping of the medication. In this instance, even if someone is able to obtain Jenda Tags that are not deactivated but are intended for a specific product/medication, the tag or server can be programmed to notify the user with pertinent information, such as the product is a genuine medication name/type consisting of a dose size, manufactured by X company, on date Y, part of batch Q, intended for sale in country Z and provide a picture of what the medication is supposed to look like. This prevents counterfeiters from using tags that were intended for cheaper medications (e.g. non-name brand or other types of medications), or other products (e.g. a tag intended for a watch), or for products meant for sale in other countries, from reusing the tags on more expensive products in an attempt to counterfeit the more expensive product. The scanner of the product would immediately be able to verify if the medication is the appropriate medication the patient is supposed to take or supposed to take at that time. This system also has the advantage that if there is a recall or the manufacturer realizes that there was a defect with a batch or needs to notify the user of some other pertinent information such as a newly discovered side effect or benefit. The user would be notified upon scanning the tag that the medication may not be safe to take or has a recall instituted and/or inform the user on actions to take. The system can also be set to provide the user with the medication information sheet or a link to the information sheet each time the medication is scanned if the user desires any information about the medication.

Doctors, pharmacists and users of the medication could chose to opt-in such that when a prescription is written it is tied with a unique Jenda Tag code or with a particular physical Jenda Tag. The doctor can send the prescription that is tied to the code to the pharmacy, which would fill the prescription accordingly. With each step of filling the prescription, the same code can be scanned to verify the prescription and the contents of the container match the prescription. Alternatively the patient can be issued a physical Jenda Tag, which they can bring to the pharmacy to be scanned, verifying the prescription and the patient instead of a signed piece of paper that can be forged or requiring the pharmacy to contact the doctor to verify a prescription. When the prescription is scanned or the medication scanned prior to use, the user can be notified of possible dangerous combinations such as nitrates for chest pain medications and others, such as sildenafil, that can lead to unhealthy conditions or even death. This method would take advantage of the multiple scanning ability of the tag by different programs, users or servers set to receive different kind of scans. It can also be used with a combination of tags, one that notifies of the type of medication and another that can only be scanned to create a unique token by the user. The doctor could also use a method of associating a code with a patient and specific prescription to have the servers notify the patient upon the patient scanning or prior to taking the medication on specific actions to take, such as, not to take the medication or to take it at another time/date, a different dosage or to remind the patient that they have missed a dosage etc.

Jenda Tags can be set to allow for gifting or transfer by the user or in database 102. This can be used for transferring the custody of the product from one authorized purchaser, middleman, shipper, etc. to another. In this way, the delivery of the product can be tracked to ensure proper handling and shipping methods are followed. E.g. if the material within the shipment is to be shipped from one location to another and the shipment packing is tamper evident, the shipment can be tracked and ensure that only authorized personnel receive or handle the shipment. This can be done with a single tag on the exterior that allows for multiple scans, or using multiple tags. In the single tag example, certain accounts that have mobile devices registered are associated with the shipment tag, and any other device that scans the shipment would notify the shipper and ultimate receiver of possible tampering of misdirection of the package. In the case of multiple tags, it can be set that each tag is to be associated with an account such that at each location along the shipping route, a single tag is to be scanned in the traditional manner and notifications of these scans are forwarded to users to track the shipment. These scans can also be uploaded to a website such that a tracking number can be entered to determine where a product was last scanned or which tag was last scanned. If someone who is not authorized to receive the shipment scans the tag, it can be communicated to the recipient and sender or other interested parties via server 100 that the shipment was intercepted or handled in an unauthorized matter. This can also be used in a situation where a shipment or product is lost and is subsequently scanned by someone who finds the product. If the code is deactivated or the status indicates it was not received by the intended authorized recipient, server 100 can communicate to the mobile device used to scan the package certain information such as a request send/forward the package to a certain address with a guarantee that postage will be paid by recipient or directions to destroy the package or take any other action the manufacturer or sender of the package has set the server to communicate to a mobile device that scans the tag. This can include providing the finder of the package with incentives such as rewards for taking certain actions with the found item. As mentioned previously, the scanning of the code can provide information to the central database to help locate where the Jenda Tag was scanned or by who such that follow on actions can be taken to include deactivating all or some of the tags that are associated with that particular Jenda Tag that was scanned.

Jenda Tags can also be used for products such as shoes, handbags, watches, jewelry, electronics, toys, baby formula, medicine, health supplements, beers, wines, and other alcoholic or non-alcoholic beverages, collectable items, or any other product or good that each time one is purchased, the purchaser can scan a Jenda Tag associated with the product to verify the product is genuine. This overcomes a major need in countries such as China where counterfeiting is a major economic hardship and in cases involving alcoholic beverages or medications can lead to serious injury or death when low quality or dangerous ingredients are used. In addition to simply verifying if the product is genuine, the user can have software 111 interact with other applications on their mobile device. This can include sharing the results of a scan or other information, such as product and brand that were scanned with social media services such as Foursquare or Facebook. Actions can include automatically “check-in” to the location, or providing social media messages that the user is enjoying a drink, food product, new pair of Y brand shoes, etc. at location X. The social media messages can also be used in case a non-authentic product is scanned. In this case the user can have the non-authentic scan be reported in a similar way or to post it on Yelp that the product Q they received was a non-authentic product at Z location. The user can also choose to opt-in to automatically provide scan results to manufacturers or brand owners for statistical information or identification of where their genuine products are being sold and where counterfeits of their products are being sold. There can also be an option to allow for manual reporting if the user opts-out of automatic updates.

Database 102 can gather the data from multiple accounts and aggregate data for statistical modeling. According to one particular embodiment of the present invention, the data from each scan may comprise, for example, product SKU, location (e.g., GPS or other location data provided via the device), information inputted by the user (e.g., location name or explicitly indicated location), device model, operating system, etc., any demographic information known about the user. This set of information can facilitate subsequent analysis to understand, for example, how often and quickly a person is scanning tags in a specific location or area, or how quickly tags are being scanned by multiple people in an area. This can include both genuine and non-genuine scan results. This data can be used to develop heat maps, data charts or other visual or written displays of how quickly products are being sold, how often they are genuine and how often they are not, which areas are better targets for marketing due to sales etc. This analysis can be expanded to other trends and inventory control because of the ability to track individual Jenda Tags and all the associated information that is stored in database 102 or by the manufacturer with regard to the products that have been tagged. Marketing firms can also obtain this data from multiple manufacturers or from Jenda itself and produce data metrics and comparisons of how different products fair in different areas, how the same product sells in different areas, at different times, etc. Furthermore, users can be compensated in various ways for sharing this information directly, or any other information they are willing to share with the manufacturers, brand owners, marketing firms, social media and/or retailers for any reason. The mobile device users can also set the social media interactions to be automatic or to provide specific kinds of data on each scan, or on a period basis. E.g. each time the user buys 5 of a product, the information with regard to those 5 sales is sent out, or simply the fact that 5 transactions have been completed is forwarded. This can be controlled in any standard way through pull requests from the data gatherer, e.g. database 102, manufacturer, set to automatically push data each time certain events or criterion are met or manual push by the user. What is shared can similarly be determined by the options selected by the mobile device user of the software 111 or settings provided by the data gatherer that are provided. Similar to scans of non-genuine articles, genuine article scans can have automatic actions be programmed into software 111 by the user upon a scanning of the tag. The manufacturers can also provide suggested social media status/notification updates to the users through software 111.

Manufacturers and service providers can join to provide services or other products, e.g. if a user scans a certain number of alcoholic beverages within a given time frame, the user could receive a notification or phone number for a taxi or sober ride program. Similarly, purchases of multiple automatic watches may have a notification or coupon/discount code for a watch winder or information on a personal property insurance carrier that specializes in the product the user has purchased and scanned.

Maintaining a record of both counterfeit and authentic product purchase scans allows for the creation of a map of locations where authentic products are sold and where counterfeits are sold. This map can be provided to users through software 111, posting through social media or other websites. This map would create an incentive for honest retail locations to encourage their consumers to scan their products as well as discourage the sale of counterfeits through public shaming. Each authentic scan can provide an increase in an authenticity rating for that retailer which is stored in database 102 and can be displayed on a map of the software 111 of authentic locations. Alternatively, a retailer is associated with an authenticity rating based on counterfeit scans such that their rating goes down with each counterfeit scan, or a combination of counterfeits and authentic scans. This score can also be shared by manufacturers or retailers with other mapping software such as Google Maps or any other mapping program. The rating score can also be provided to other rating websites such as TripAdvisor, Yelp etc. to help score the retailers with regard to the quality/authenticity of products sold.

In addition to a high authenticity/low counterfeit score the retailers would enjoy, software 111 can be used to provide discount or loyalty codes to consumers. This discount can be funded by the retailer or manufacturer. This can be done to help boost authenticity scores, or to encourage consumers to scan their products and reward honest retailers. Manufacturers can also use high authenticity/low counterfeit scores to reward specific retailers with lower wholesale prices or providing them with limited edition products etc. Scans of non-authentic goods can be used to reduce an authenticity score either proportionately or by a different amount compared to authentic product scans. In addition to an authenticity score, this data can provide rankings of retailers based on sales volume, proportion of products sold and scanned that are authentic to non-authentic or if certain products tend to be authentic while others are not, the different product categories can be ranked for the retailer. These rankings and scores can all be displayed on the map in software 111 to the user, used by manufacturers and/or brand owners or provided or sold to other companies.

Jenda tags can also be used in combination for review purposes to only allow review of authentic products for sites such as Angie's List, Yelp, store webpages, manufacturer, brand owner and any other webpage that allows for reviews of products. With Jenda tags, reviews could be limited to only those items that have been authenticated as genuine using the Jenda application. This can be used for location based purposes, e.g. only items bought at the store front can be scanned and those reviews can be attributed to the store or restaurant for its services because the locations of the scans and where the goods were to be sold are maintained by Jenda. This prevents locations from being able to pay for people to write positive or negative reviews for products that were never purchased or used. Only authentic products could be reviewed to have a true picture of the quality of the products. In this embodiment, non-authentic scans can be registered and reviewed for the location they were purchased that they are selling non-authentic products or not be reviewable at all, but would not allow for review of the product itself to be tied to the manufacturer.

The scanning of a Jenda Tag can have further interactions than just providing an authentic/non-authentic visual notification on the display associated with mobile device 110. The mobile device 110 can display a unique authentication image upon authentication of the product, play a sound and/or vibrate in certain patterns or take any other action the mobile device 110 can be induced to perform to provide indication of a valid or non-valid scan. Brands owners or manufacturers can “lock” their scan notifications such that the notification will only display their logo, trademark or other unique notification upon a scan that passes authentication. Alternatively, if the notification is not locked or not all aspects of the notification are locked, the mobile device owner can set the desired alert(s) or notification(s) based on the specific product, brand, product type, location or any other characteristic or scan event attribute they choose.

Manufacturers and/or brand owners can provide users with further information upon the scanning of their Jenda Tag by a mobile device. This can include providing the user with a suggestion such as if the purchaser likes product X, the user should consider buying product Y or avoiding product Z because it may not match their preferences based on past purchases, interactions, ratings or other analysis that may indicate preferences. These recommendations can have rankings associated with them that can be sold such that if a user scans product Q from manufacturer A, manufacturer B can purchase association credit such that when product Q is scanned, the mobile device 110 displays the suggestion to try product R from manufacturer B based on the scan of product Q from manufacturer A. Alternatively, users can choose to provide information to the manufacturer or brand owners. Information such as a user likes products R from company B and wants a recommendation on an alternative from company A, or a general alternative from any company since product R was unavailable, the scan of product R was non-authentic or the consumer simply wishes to try something different. The consumer can also provide the manufacturer with information of ratings of products through ranking of what they purchased subsequent to scanning the product. This information can be used to help provide advertisements of other products the user may like or products in the vicinity of the current scan, e.g. a consumer scans a drink at location A, and Jenda system provides that there is a similar/identical product available at location B which is within a specific set distance of the user. The user could also ask for recommendations within a defined area from their location that provide Jenda authenticated products with a specific ranking or above. Alternatively, consumer habits can be analyzed to send notifications prior to their normal activity time or just after normal activity time for specific advertisements or product recommendations. These recommendations could be based on that particular consumer's past habits or extrapolated from aggregate data of multiple accounts and making recommendations or offers to the consumer based on these predictions. This can also be done in near-real time for each Jenda Tag the consumer scans. These can also be provided if a non-genuine scan is received, e.g. suggestions of where to go to obtain the same product that is genuine from another retailer. This can be based on the consumer's location, retailer ratings and their location in relation to the consumer and any other pertinent data.

Jenda Tags can be set to allow for multiple devices to scan a single tag. In this way, central server 100, software 101 and/or database 102 can be set to allow only a single consumer token to be associated with the tag, but to have multiple law enforcement tokens be associated with the unique tag. This can also be enacted through software 101 and/or software 111 that is specially modified and programmed for government or law enforcement application only. In this way, customs officials can scan import or export shipments and verify that the products are genuine and belong to the shipper and are authorized for shipment without invalidating the tag for the consumer who will scan the Jenda Tag at a later time. The same method can be used by police if they find merchandise that the police suspect is stolen using the law enforcement modified software. The officer can scan the Jenda Tag and have specific information returned to the officer or agency to include the previous authorized owner and the owner's information such as address or contact information. This owner could be the manufacturer or a previous purchaser or giftee of a product. This would be especially helpful for expensive retail items that are easily stolen such as expensive watches or diamonds which can have the Jenda Tag laser inscribed or etched onto the item. This method can allow the registered owner to verify if the product is genuine or has been swapped out by someone such as a jeweler attempting to replace a genuine diamond with a different stone. This method can also provide owner information to any scanner other than the registered owner of the product. Alternatively, the product can be reported being stolen to the database and that any subsequent scan of the tag provides an authentication result as the product being stolen goods. This can be combined with the multi notification option. If a product is reported as stolen by the registered owner and is subsequently scanned, the scan and related information are forwarded to the owner and/or law enforcement and/or insurance, while the scanner received a message that the product is stolen. This can help locate the item and prevent it from being sold because each authentic item by that manufacturer would have a unique Jenda Tag associated with it. The registered owner of the product can also be notified when the product is scanned by law enforcement to indicate to the user that the product has been found. It can also provide further information such as which law enforcement office/department to contact to reclaim the product or to help in an investigation.

Software 101, which contains or works with database 102, running on a server 100 can contain user accounts such that each user can choose to register a mobile device, or multiple mobile devices. If the user has more than one mobile device and wishes to be able to use them interchangeably, the account can allow for maintaining multiple devices such that if a tag is scanned by a mobile device for the first time, subsequent scans with the same device or any other device associated with the account would provide that the product is genuine/passed authentication. Another advantage of the account is that if a user has a single device, or multiple devices and one or more devices is lost, the user can log onto their account from a standard computer or any other device that can interact with server 100 and log into their account and report a device as stolen. This prevents the person who later obtains that mobile device 110 from being able to scan goods associated with the account the lost/stolen mobile device was associated with and showing that the product is authentic. This also works if the user has a single mobile device which is replaced for any reason. This is especially useful in situations where expensive or unique items are resold after the initial purchase and the Jenda Tag is used for authentication in the secondary sale and subsequent transfer. Once the user obtains a new mobile device, the user can update his/her account and transfer all the previous Jenda Tag and mobile device associates to be associated with the new device. This would allow for authentication of all the Jenda Tags that are associated with the user's account and previously could only be associated with the other device. Users can also log onto their accounts and review their purchase histories. Alternatively, these purchase histories can be maintained by the manufacturers and users can log onto the manufacturer's page/account to view their purchase history.

Jenda Tags in general are two layer industrial strength tags, with a peel-off top layer, with unique QR code. The peel-off layer may also be a scratch off layer or be removable by other methods. These kind of tags are generally used on the outside packaging of a product such as on a bottle, the backing of a medication packet, or any exterior packaging of an item that cannot have the tag directly affixed to it or affixing the tag to the product itself would be undesirable. The tag can alternatively be permanently attached onto a product as a separate tag or in other instances can be permanently written, etched or marked in some fashion onto the product itself with a covering or without a covering in cases where the product is contained within some other packaging that must be destroyed or tampered with in order to obtain access to the Jenda Tag itself. The Jenda Tag can be a visually readable item by standard optical, infrared, or other scanners but also does include smaller variations that require special readers such as a microscope to be able to read the tag or other specialized devices to be able to read it. The tag can also include Radio Frequency Identification (RFID) information in addition to or in place of the visual code. The outer layer of the tag in this situation can also act as a RF shield. If the tag layers do not act as an RF shield, the packaging itself can be made of a shielding material that does not allow for scanning without opening and in so doing tampering or destroying the seal containing the RFID information of the tag.

Alternatively Jenda Tags can be single layer tags that do not have a covering for embodiments where multiple scans are contemplated such as inventory control situations or tracking of packages etc, otherwise they can have all the attributes listed above.

In some implementations, the Jenda tags, especially those more permanently attached or written onto a product or its packaging, may be “recycled” when the product's container or packaging is reused. For example, a trusted beverage re-bottler may batch process a number of bottles bearing previously used Jenda tags and have the central server re-associate them now with a new batch of genuine products for future authentication.

The communications between the mobile device 110 and the central server 100 can be secured by any normal means of securing any section of it such as encrypting communications, requiring user authentication to connect to the network or even biometric authentication of an user by way of finger print or iris scanner or any other generally known biometric authentication system. The communications between mobile device 110 and server 100 can be through a private network if one is provided or through normal communications pathways that can carry data.

In one particular embodiment of the present invention, the above-described identification tags with authentication codes may be affixed to beer bottles of a trusted origin (e.g., from a domestic or foreign brand-name brewer). Employing the above-described authentication procedures with the Jenda central server, not only could counterfeiting and black-market sales of the brand-name beer be deterred, the brewer may also turn beer-drinking into an interactive experience, own or improve the consumer relationship, and strengthen brand loyalty.

For example, upon scanning and authenticating a bottle and potentially as part of that process, the consumers may “interact” with their beer by sharing their beer-drinking experience on social media such as Facebook, Twitter, Renren, Weibo, or WeChat, etc. Both the consumer and the brewer and/or distributor/retailer(s) could track the individual's drinking history, generating a personal diary and/or unprecedented sales data. The scanning and authentication process provides a valuable opportunity for the brewer and/or distributor/retailer(s) to interact with the consumer in real time, for example, to provide upselling, promotions, digital marketing campaigns, games, and more.

This embodiment of the present invention also allows the brewer to own and improve a direct relationship with the beer consumers without going through the distributor/retailer(s). For example, the brewer could gain unprecedented knowledge of where, when, and how much the consumers drink. Extensive real time data and heat maps may be obtained without relying on such middle-men as the distributor/retailer(s) or market analysts. The brewer may effectively deploy digital marketing campaigns directly to consumers: identify consumers by location and previous beer preference; upsell or cross-sell in real time from the palm of consumers' hands (via their portable devices). The brewer may also acquire knowledge of exactly which bars, clubs, and retail stores sell its products so as to gain insights including sales volume by SKUs and to plan better targeted in-store marketing.

By implementing this embodiment of the present invention, the brewer may enjoy additional advantages. For example, the product authentication and social media capabilities may become a true product differentiator from all other beer products. The brewer's products may become the only beer the consumers can drink with confidence, particularly in markets where counterfeiting is rampant and widespread. The consumers may build their records and diaries of drinking experiences related to the brewer's products. The consumers may effectively become social media salesmen for the brewer. The brewer may have direct access to digital marketing promotions and offer upselling, cross-marketing, contests and so on.

The invention is capable of incorporating standard advertising methods such as displaying advertisements prior to or subsequent to scanning a tag, overlaying pop-ups or ads including commercials. Sponsors this way can reach a targeted audience of those who scan their products or certain other kinds of products or their products are scanned at specific areas or locations and so can to provide more information and advertising to these users.

Affixing to a product includes but is not limited to physical attachment of the tag to the product itself, it can be printed on the product, inserted inside a product, built into the product etc. Affixing to a product also includes attaching to the packaging of the product, or including inside the packaging of the product, or any other way of ensuring that the tag is not separable from the product without tampering with the product or its packaging.

Mobile device includes but is not limited to cellular telephone capable of scanning the unique tag code, having unique device identifiers such as an International Mobile Equipment Identifier (IMEI) and/or International Mobile Subscriber Identifier (IMSI) or other unique mobile device identifier (or just a username/password combination for some implementations) and capable of running the required software. The mobile device also includes laser and optical scanners capable of reading the unique tag code, that have unique device identifiers e.g. a unique scanner serial number and is capable of running the necessary software. Mobile device can have the software run on a separate piece of equipment containing a processor that has unique identifiers to which a generic scanner is attached, but the combination of scanner and processor has a single unique device identifier that cannot be duplicated.

The software application that enables the mobile device to communicate with the central server 100 and scan the unique tag codes is a software application that may be a mobile app developed by the system designer, and distributed to customers through an app store such as Apple iTunes, or Google Play. In other embodiments, the software application may also be specialized native software designed for use on mobile devices. In these embodiments, the software applications may be installed and maintained privately, without being distributed through a public third party app distributor, such as Apple iTunes, or Google Play. In other embodiments, the software application may be part of an application with much more broad functionalities. For example, the product authentication capabilities of the Jenda software may be included in a popular messaging application such as WhatsApp, WeChat (or WeiXin), or it may be part of a website that does not require the user to download any special software to their mobile device.

In other embodiments, a first QR code or other machine-readable code may be displayed on a unit of product or its packaging without being covered, thereby allowing consumers and other parties (including retailers and distributors) to scan the code and test its authenticity using methods described above. In this embodiment, however, the scanning of this code would not register any device to any database and could allow multiple scans by multiple devices to take place without displaying a message that indicates that the product is not genuine to any user.

In this embodiment, a second QR code or other machine-readable code or human-readable alphanumeric text would be printed underneath a covering that must be destroyed upon removal or this second code may be printed inside the product's packaging (therefore hidden from plain view). This “second code” would function similarly to embodiments of the Jenda Tag that have been described above. Upon purchase of the product, the user is encouraged to remove this tamper evident covering or open the product's packaging to scan the second code or type in the alphanumeric text using application 111. Scanning this second code or typing in this text would be recognized by central server 100 as a user purchasing the product. This user's unique device ID and other information would then be saved to a corresponding database and any other scans of any code on this Jenda Tag by any other device would indicate a failure to authenticate, as detailed in embodiments above. Additionally, after central server 100 recognizes the product as “purchased,” scanning the non-covered, first code would similarly result in a failure to authenticate for any user other than the first user to scan the covered Jenda Tag or type the covered text into application 111. An incentive such as a coupon or entry into a raffle may be provided to the user as an added inducement to register the product as “purchased” by scanning the covered code or text.

In this embodiment, many users would be able to know that a product is authentic before completing a purchase, and illicit product of fake Jenda Tags with the same code as appears without covering on authentic products would continue to be impossible to produce at scale, as the first user to confirm the product as their own would render all the illicitly produced Jenda Tags unusable. Moreover, claiming a Jenda Tag as “purchased” still requires tampering with or otherwise destroying a product's packaging or Jenda Tag.

In order to eliminate the possibility that a counterfeiter purchases one genuine product and reproduces multiple counterfeits with the same non-covered Jenda code without providing the covered code (thereby making it impossible for any user to ever claim the product as purchased), application 111 will indicate to all users that scan non-covered codes that authenticity cannot be entirely guaranteed until the product is purchased, the covering is removed, and the second code is scanned. This same message will indicate that if no second code exists on the product, it fails authentication.

In yet another embodiment, a user whose device or account is associated with a given Jenda Tag value may use application 111 to indicate his intention to sell the product. In this case, the user may indicate a 3^{rd} party such as eBay, Taobao, Amazon.com, or other marketplaces where the sale will take place. The indicated 3^{rd} party would then be given special access through special software that would allow them to verify the product's authenticity when they receive the product and declare it in a way such that a new user (the buyer in this sale) may scan the Jenda Tag to associate the buyer's device or account with the Jenda Tag code and product.

The mobile device programming can be programmed in any programming language or be designed to run on a computing device that has unique identifiers the software can import. Mobile devices (e.g., cellular smart telephones, laptops, desktops, notebooks, tablets, etc.) typically include a variety of computer readable media that can form part of the system memory and be read by the processing unit. These devices include or can be connected to a reader that is capable of scanning the unique tag code. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by a processing unit. The data or program modules may include an operating system, application programs, other program modules, and program data. The operating system may be or include a variety of operating systems such as the Macintosh® OS or iOS operating systems, Microsoft Windows® operating system, the Unix operating system, the Linux operating system, the Android operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Apache™ operating system, an OpenStep™ operating system or another operating system of the platform.

The processing unit that executes commands and instructions may be a general purpose computer, but may utilize any of a wide variety of other technologies including a special purpose computer, a microcomputer, mini-computer, mainframe computer, processor, CPU (Central Processing Unit), programmed micro-processor, micro-controller, peripheral integrated circuit element, a CSIC (Visitor Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

It is appreciated that in order to practice the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations. As long as the combination of components for the mobile device is capable of developing a single, unique device identification code the arrangement of components does not hinder the operation of the system. For the central server 100, a unique device identification code is not required and the central server 100 can be arranged in any physical layout to function properly.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage may be implemented using one distinct memory portion as described or above may be performed by two memory portions or additional memory portions.

The memory will include at least one set of instructions that is either permanently or temporarily stored. The processor executes the instructions that are stored in order to process data. The set of instructions may include various instructions that perform a particular task or tasks, such as those shown in the appended flowchart. Such a set of instructions for performing a particular task may be characterized as a program, software program, software, engine, module, component, mechanism, or tool. The computer may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Generally, it should be noted that the components depicted and described herein above may be, or include, a mobile device or multiple mobile devices, a computer or multiple computers. Although the components are shown as discrete units, all components may be interconnected or combined. The components may be described in the general context of computer-executable instructions, such as program modules, being executed by a computer. Generally, program modules include routines, programs, objects, applications, components, data structures, etc., that perform particular tasks or implement particular abstract data types.

Commands and information may be entered into the mobile device through a user interface that includes input devices such as a keyboard and pointing device, commonly referred to as a mouse, trackball or touch pad. Other input devices may include a microphone, joystick, game pad, optical scanner, voice recognition device, keyboard, touch screen, toggle switch, pushbutton, or the like. Input devices include those that can detect recognize hand movements or gestures, such as in the case of gesture set supported by Android or the swipe movements recognized in iOS-based devices. These and other input devices are often connected to the processing unit of the mobile unit through a user input interface that is coupled to the system bus, but may be connected by other interface and bus structures, such as a parallel port, game port or a universal serial bus (USB) or integrated into the system.

As discussed above, a user interface is utilized by the mobile device that performs a set of instructions such that the processing machine processes data for a user. The user interface is typically used by the processing machine for interacting with a user either to convey information or receive information. However, it should be appreciated that in accordance with some embodiments of the invention, it is not necessary that a human user actually interact with a user interface used by the mobile device of the invention. Rather, it is also contemplated that the user interface of the invention might interact, i.e., convey and receive information, with another processing machine, rather than a human user. Further, it is contemplated that a user interface utilized in the invention may interact partially with another processing machine or processing machines, while also interacting partially with a human user.

One or more monitors or display devices may also be connected to the mobile device 110 or the central server 100. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Various networks may be implemented in accordance with embodiments of the invention, including a wired or wireless local area network (LAN) and a wide area network (WAN), the Internet, wireless personal area network (PAN) and other types of networks. When used in a LAN networking environment, components of the system may be connected to the LAN through a network interface or adapter. When used in a WAN networking environment, devices typically include a modem or other communication mechanism. Modems may be internal or external, and may be connected to the system bus via the user-input interface, or other appropriate mechanism.

Mobile devices may be connected over the Internet, an Intranet, Extranet, Ethernet, or any other system that provides communications. Some suitable communications protocols may include TCP/IP, UDP, or OSI, for example. For wireless communications, communications protocols may include Zigbee, IrDa, Wi-Fi, WiMax, 2G, 3G, 4G, Ultra-Wideband and Long Term Evolution (LTE), Broadband Global Access Network (BGAN), Inmarsat, Iridium, or other satellite data connection protocols capable of transmitting the data. The wireless communications protocol may also include short-range communications devices and protocols, such as RFID, Bluetooth, or Near-Field Communication radio transmissions. Furthermore, components of the system may communicate through a combination of wired or wireless pathways.

The processing unit that executes commands and instructions may be a mobile device or a general purpose computer, but may utilize any of a wide variety of other technologies including a special purpose computer, a microcomputer, mini-computer, mainframe computer, processor, CPU (Central Processing Unit), programmed micro-processor, micro-controller, peripheral integrated circuit element, a CSIC (Visitor Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

In addition, the instructions and/or data used in the practice of the invention may utilize any compression or encryption technique or algorithm, as may be desired. An encryption module might be used to encrypt data or the communications pathways used by the data. Further, files or other data may be decrypted using a suitable decryption module.

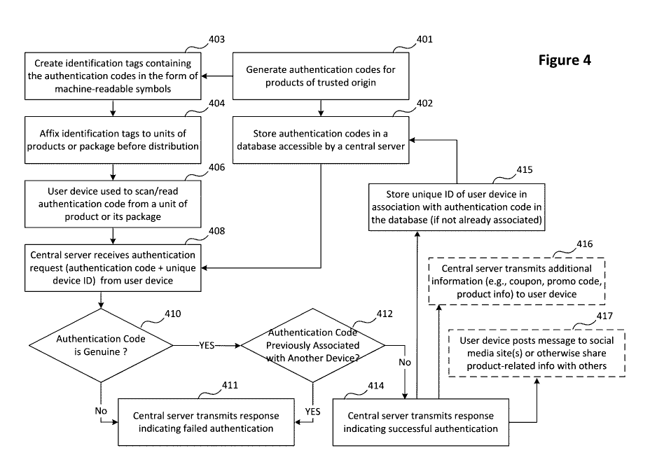

FIG. 4 is a flow chart illustrating an exemplary method for product authentication in accordance with an embodiment of the present invention.

In Step 401, authentication codes may be generated for certain products of trusted origin. For example, the authentication codes may each be a unique combination of alphanumerical characters or of other composition sufficient to be distinguished from one another. According to some embodiments, one unique authentication code may be generated for each unit of product, such as a bottle of beverage, a can of baby formula, or a packet of medication. The authentication codes are preferably generated by a central authority (e.g., the Jenda Tag company). Product manufacturers may act as or in partnership with the central authority to generate the authentication codes needed to accompany their products.

In Step 402, the authentication codes may be securely stored in a database accessible by a central server. The central authority (e.g., the manufacturer or distributor or an authentication service provider) may set up the central server for product authentication purposes and have the database coupled to the central server and storing the authentication codes in connection with the corresponding products. According to one embodiment, the database may maintain a record associating the group of authentication codes with the corresponding product name, type, model number, manufacturer, and/or origin. According to another embodiment, the database may maintain more detailed records associating each authentication code with a corresponding unit of product, for example, by linking each authentication code with the product serial number or other unique identifier of the corresponding unit of product.

Meanwhile, in Step 403, identification tags may be created containing the authentication codes in the form of machine-readable symbols. For each unit of product or for each package of products, an identification tag may be created. The authentication codes may be encoded or incorporated into symbols (e.g., 1-D or 2-D bar codes, QR codes) that could be read or scanned by a camera or scanning device which is sometimes part of a user computing device such as a smart phone or tablet. According to a preferred embodiment, a two-layer peel-off label may be a suitable form of the identification tag whose top layer may be peeled off to reveal the machine-readable symbols and the peeled-off layer is preferably impossible to re-attach to the underlying or base layer (therefore making the label tamper-evident).

In Step 404, such identification tags may be affixed to units of products and/or their packages before distribution. The tags may be attached to the products and/or their packaging either by the manufacturer or by the distributors, wholesalers, or dealers prior to further movement of the products down the stream of commerce. Preferably, the central authority (or central server) is updated with the status of these products and/or their tags once they enter the distribution chain.

In Step 406, a user device may be used to scan or read the authentication code from a unit of product or its package. The user device may be any electronic equipment with code-scanning or code-reading capabilities, such as a commercial barcode reader, an inventor-control hand-held terminal, a smart phone, a wearable device, a tablet computer, a phablet, or a laptop computer. The person using the user device to scan the authentication code is typically a consumer or end user of the product but may also be another party in the product distribution chain. With a mobile app, for example, the user device may scan or read the identification tag to recognize and decode the machine-readable symbol to extract the authentication code. The user device may then put together and transmit to the central server an authentication request containing at least the authentication code (or a value or symbol derived from or corresponding to the authentication code) and a unique identifier of the user device.

In Step 408, the central server receives the authentication request from the user device. Since the user device is out in the field and could be anywhere in the country or in the world, the authentication request is typically received via a telecommunication network (including wired and/or wireless portions) and could arrive at the central server at any time. The central server immediately processes the authentication request by making a number of determinations.

For example, in Step 410, the central server may determine whether the authentication code included in the authentication request is a genuine code. The central server may query the database which stores the previously generated authentication codes in an attempt to find a match with the received authentication code. If no match is found, it may be determined that the received authentication code is not genuine. As a result, the central server may issue a response to the user device in Step 411 indicating a failed authentication—that is, the particular unit of product may be a counterfeit. If a match is found in the database, then it may be determined that the received authentication code is genuine and the decision process moves on to Step 412.

In Step 412, the central server may determine whether the authentication code is already associated with another device other than the user device submitting the authentication request. If it is decided, based on database record, that the received authentication code is previously associated with another device, then it may be concluded that the underlying product is not authentic and a response may be issued accordingly in Step 411 to indicate a failed authentication.

If the received authentication code has not been previously associated with another device—that is, the received code either has never been associated with any device or was only previously associated with the same user device now requesting authentication—then the central server may issue a response in Step 414 indicating a successful authentication. If the received authentication code has not been associated with any device, then, in Step 415, the unique identifier of the user device requesting authentication may be stored in the database in association with the received authentication code. This pairing of the device ID with the authentication code may be maintained in the database records for reference in future product authentication operations.

In Step 416, in consequence of the successful authentication, the central server may transmit additional information to the user device in connection with the underlying product, such as coupons, promotional or discount codes, and/or product information.

In Step 417, upon receiving the confirmation of authenticity from the central server, the user device may be used (e.g., through its Jenda Tag app or other software program) to post one or more messages to social media site(s) or transmit message(s) directly to others to share product-related information or experience and interact with family, friends, or other people.

It should also be readily apparent to one of ordinary skill in the art that the presently disclosed invention may be implemented in a wide range of industries and sectors. The various embodiments and features of the presently disclosed invention may be used in any combination, as the combination of these embodiments and features are well within the scope of the invention. While the foregoing description includes many details and specificities, it is to be understood that these have been included for purposes of explanation only, and are not to be interpreted as limitations of the present invention. It will be apparent to those skilled in the art that other modifications to the embodiments described above can be made without departing from the spirit and scope of the invention. Accordingly, such modifications are considered within the scope of the invention as intended to be encompassed by the following claims and their legal equivalent.

From the foregoing, it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A computer-implemented system for product authentication, comprising:
a central server comprising at least one computer processor configured to generate at least one unique authentication code pre-associated with one or more products of trusted origin;
a database coupled to said central server and storing the at least one unique authentication code;
an identification tag affixed to a unit of product or its package, the identification tag containing one of the at least one unique authentication code in the form of a machine-readable symbol; and
said at least one computer processor of said central server being further configured to:
receive an authentication request via a telecommunication interface from a user device, said authentication request comprising (a) an authentication code purportedly derived by said user device scanning or reading said identification tag affixed to said unit of product or its package and (b) a unique identifier of said user device,
determine (i) whether said authentication code matches one of the at least one unique authentication code stored in the database and (ii) whether said identification tag has been previously scanned or read by another user device other than said user device, and
transmit a first response to said user device to confirm authenticity of said unit of product if said authentication code matches one of the at least one unique authentication code stored in the database and said identification tag has not been previously scanned or read by another user device other than said user device.

2. The computer-implemented system according to claim 1, wherein said at least one computer processor of said central server is further configured to:
record, in the database, electronic data comprising said unique identifier of said user device in association with said authentication code.

3. The computer-implemented system according to claim 1, wherein said at least one computer processor of said central server is further configured to:
transmit a second response to said user device to indicate a failure of authentication if said authentication code matches none of the at least one unique authentication code stored in the database.

4. The computer-implemented system according to claim 1, wherein said at least one computer processor of said central server is further configured to:
transmit a third response to said user device to indicate a failure of authentication if said authentication code matches one of the at least one unique authentication code stored in the database but has already been associated with another user device other than said user device.

5. The computer-implemented system according to claim 1, wherein said at least one computer processor of said central server is further configured to:
transmit a fourth response to said user device to confirm authenticity of said unit of product if said authentication code matches one of the at least one unique authentication code stored in the database but has already been associated with said user device.

6. The computer-implemented system according to claim 1, wherein the determination of whether said identification tag has been previously scanned or read by said user device is based on data records in the database indicating whether said authentication code already been associated with said unique identifier of said user device.

7. The computer-implemented system according to claim 1, wherein said at least one computer processor of said central server is further configured to receive, either as part of said authentication request or in a separate transmission, additional data concerning said unit of product or a related transaction, said additional data selected from a group consisting of:
a location of said unit of product or where said related transaction occurs,
a time when said related transaction occurs,
a price of said unit of product in said related transaction, and
other transactional detail of said related transaction.

8. The computer-implemented system according to claim 1, wherein said at least one computer processor of said central server is further configured to:
transmit an authentication response to another recipient in lieu of or in addition to said user device.

9. The computer-implemented system according to claim 1, wherein said at least one computer processor of said central server is further configured to:
transmit authentication responses having different information to at least two recipient devices.

10. The computer-implemented system according to claim 1, wherein the database stores a group of authentication codes with their status linked together and dependent upon a status of another authentication code.

11. The computer-implemented system according to claim 1, wherein said at least one computer processor of said central server is further configured to:
transmit, apart from said first response, additional information concerning said unit of product or information concerning another product or service.

12. The computer-implemented system according to claim 1, wherein said identification tag comprises a peel-off cover that conceals said machine-readable symbol.

13. A computer-implemented method for product authentication, comprising:
generating, by at least one computer processor, at least one unique authentication code associated with one or more products of trusted origin;
storing the at least one unique authentication code in a database accessible by a central server;
creating an identification tag containing one of the at least one unique authentication code in the form of a machine-readable symbol;
affixing said identification tag to a unit of product or its package;
receiving, by the central server and from a user device, an authentication request via a telecommunication interface, said authentication request comprising (a) an authentication code purportedly derived by said user device scanning or reading said identification tag affixed to said unit of product or its package and (b) a unique identifier of said user device;
determining (i) whether said authentication code matches one of the at least one unique authentication code stored in the database and (ii) whether said identification tag has been previously scanned or read by another user device other than said user device; and
transmitting a first response to said user device to confirm authenticity of said unit of product if said authentication code matches one of the at least one unique authentication code stored in the database and said identification tag has not been previously scanned or read by another user device other than said user device.

14. The computer-implemented method according to claim 13, further comprising:
recording, in the database, electronic data comprising said unique identifier of said user device in association with said authentication code.

15. The computer-implemented method according to claim 13, further comprising:
transmitting a second response to said user device to indicate a failure of authentication if said authentication code matches none of the at least one unique authentication code stored in the database.

16. The computer-implemented method according to claim 13, further comprising:
transmitting a third response to said user device to indicate a failure of authentication if said authentication code matches one of the at least one unique authentication code stored in the database but has already been associated with another user device other than said user device.

17. The computer-implemented method according to claim 13, further comprising:
transmitting a fourth response to said user device to confirm authenticity of said unit of product if said authentication code matches one of the at least one unique authentication code stored in the database but has already been associated with said user device.

18. The computer-implemented method according to claim 13, wherein the determination of whether said identification tag has been previously scanned or read by said user device is based on data records in the database indicating whether said authentication code already been associated with said unique identifier of said user device.

19. The computer-implemented method according to claim 13, wherein said at least one computer processor of said central server is further configured to receive, either as part of said authentication request or in a separate transmission, additional data concerning said unit of product or a related transaction, said additional data selected from a group consisting of:
a location of said unit of product or where said related transaction occurs,
a time when said related transaction occurs,
a price of said unit of product in said related transaction, and
other transactional detail of said related transaction.

20. The computer-implemented method according to claim 13, further comprising:
transmitting an authentication response to another recipient in lieu of or in addition to said user device.

21. The computer-implemented method according to claim 13, further comprising:
transmitting authentication responses having different information to at least two recipient devices.

22. The computer-implemented method according to claim 13, wherein the database stores a group of authentication codes with their status linked together and dependent upon a status of another authentication code.

23. The computer-implemented method according to claim 13, further comprising:
transmitting, apart from said first response, additional information concerning said unit of product or information concerning another product or service.

24. The computer-implemented method according to claim 13, wherein said identification tag comprises a peel-off cover that conceals said machine-readable symbol.

25. A non-transitory computer-readable medium having code for product authentication, the code configured to cause a computer processor on a user device to:
scan or read an identification tag affixed to a unit of product or its package to derive an authentication code;
formulate an authentication request comprising (a) said authentication code and (b) a unique identifier of said user device;
transmit said authentication request to a central server which determines (i) whether said authentication code matches one of at least one unique authentication code stored in a database and (ii) whether said identification tag has been previously scanned or read by another user device other than said user device; and
receive, from said central server, a first response that confirms authenticity of said unit of product if said authentication code matches one of the at least one unique authentication code stored in the database and said identification tag has not been previously scanned or read by another user device other than said user device.

26. A computer-implemented method for product authentication, comprising:
generating, by at least one computer processor, at least one first unique authentication code and at least one second unique authentication code associated with one or more products of trusted origin;
storing the at least one first unique authentication code and the at least one second unique authentication code in a database accessible by a central server;
creating a first identification tag containing a first one of the at least one first unique authentication code in the form of a first machine-readable symbol and creating a second identification tag containing a second one of the at least one second unique authentication code in the form of a second machine-readable symbol, said first one and said second one being associated in said database;
affixing said first identification tag and said second identification tag to a unit of product and/or its package such that said first machine-readable symbol is visible or readily accessible for scanning without opening said package while said second machine-readable symbol is not visible or readily accessible for scanning without removing a tamper-evident cover of said second identification tag or opening said package;
receiving, by the central server and from a user device, an authentication request via a telecommunication interface, said authentication request comprising an authentication code purportedly derived by said user device scanning or reading said first identification tag or said second identification tag affixed to said unit of product or its package;
determining, by the central server, whether said authentication code matches one of the at least one first unique authentication code or one of the at least one second unique authentication code stored in the database;
if said authentication code matches one of the at least one first unique authentication code—
if an associated one of the at least one second unique authentication code has not been associated with any user device, then transmitting a first response to said user device to indicate potential authenticity of said unit of product, or
if an associated one of the at least one second unique authentication code has already been associated with some user device, then transmitting a second response to said user device to indicate a failure of authentication;
if said authentication code matches one of the at least one second unique authentication code—
if said matched one of the at least one second unique authentication code has not been previously scanned or read by another user device other than said user device, then transmitting a third response to said user device to confirm authenticity of said unit of product, or
if said matched one of the at least one second unique authentication code has already been previously scanned or read by another user device other than said user device, then transmitting a fourth response to said user device to indicate a failure of authentication.
